(19) United States
(12) Patent Application Publication
(10) Pub. No.: US 2022/0418057 A1
(43) Pub. Date: Dec. 29, 2022

(54) DOMESTIC MICROWAVE APPLIANCE WITH MICROWAVE TRAP AND METHOD FOR THE PRODUCTION THEREOF

(71) Applicant: BSH Hausgeräte GmbH, Munich (DE)

(72) Inventors: Markus Kuchler, Gstadt am Chiemsee (DE); Robert Pietsch, Palling (DE); Sebastian Sterz, Großaitingen (DE)

(21) Appl. No.: 17/771,027

(22) PCT Filed: Dec. 3, 2020
(86) PCT No.: PCT/EP2020/084419

§ 371 Date: Apr. 22, 2022

(30) Foreign Application Priority Data
Dec. 19, 2019 (DE) 10 2019 220 293.4

(51) Int. Cl. H05B 6/76; B21D 22/26

(52) U.S. Cl. CPC H05B 6/763; B21D 22/26

(57) ABSTRACT

A household microwave appliance includes a microwave treatment chamber having a loading opening, a door for closing the loading opening of the microwave treatment chamber, and a microwave trap configured to prevent microwaves escaping when the door is closed. The microwave trap is a bent sheet-metal component with a main bending edge, which is adjoined by a row of teeth at a distance. The microwave trap includes a row of bending slots in the main bending edge, with at least one of the bending slot being interrupted by a web to define slot sections.

The invention relates to a household microwave appliance, having a microwave treatment chamber, the loading opening of which can be closed by means of a door, and at least one microwave trap for preventing microwaves escaping when the door is closed, wherein the microwave trap is a bent sheet-metal component with a main bending edge, which is adjoined by a row of teeth at a distance, a row of bending slots being present in the main bending edge in parallel to the teeth. The invention also relates to a method for the production of a microwave trap of a household microwave appliance from a sheet-metal component, in which bending slots are made in the sheet-metal component along an intended main bending edge in parallel at a distance to a row of teeth arranged on the edge and the sheet-metal component is bent at the main bending edge. The invention can in particular advantageously be applied to microwave cooking appliances.

The basic forms of the shielding devices in household microwave appliances in accordance with the basic principle of a lambda quarter-wave trap have long been known and have been taken over practically without change from one generation of appliances to the next. Traps dipped into the cooking chamber are typical, as described for instance in DE 33 287 48 A1. Likewise common are variants that are positioned behind an inner glass pane of a cooking chamber door, see e.g. EP 1 426 692 A1 or DE 28 536 16 A1.

The most frequently encountered variant, which at the same time is the simplest and most convenient to manufacture, provides for a trap structure at an outer edge of the cooking chamber door, which is covered by a material that is transparent to microwaves in order to protect against damage and soiling. This trap structure has long been known, for example from US 2011/0290230 A1 and U.S. Pat. No. 5,973,305.

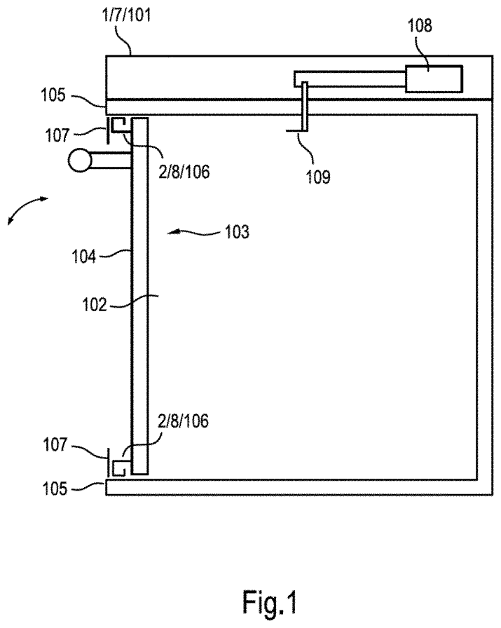

FIG. 1 shows, as a sectional view seen from the side, a sketch of a basic structure of a household microwave appliance in the form of the latter variant of a microwave cooking appliance 101. The microwave cooking appliance 101 has a cooking chamber 102 to which microwaves can be applied, the loading opening 103 of which can be closed by means of a door 104 which is impermeable to microwaves. To prevent microwaves from passing through a gap between the door 104 and a flange 105 surrounding the loading opening 103, the door 104 is provided with a microwave trap 106 in the form of a lambda quarter-wave trap running circumferentially around the edge. The microwave trap 106 is here protected by a cover 107 made of a material which is transparent to microwaves, e.g. made of plastic. The microwaves are generated by means of a microwave generator 108 and are directed into the cooking chamber, e.g. via a rotary antenna 109. The “operating frequency” of the microwaves generated by the microwave generator 108 can be e.g. 2.45 GHz±20 MHz or more rarely may also lie between 902 MHz and 928 MHz.

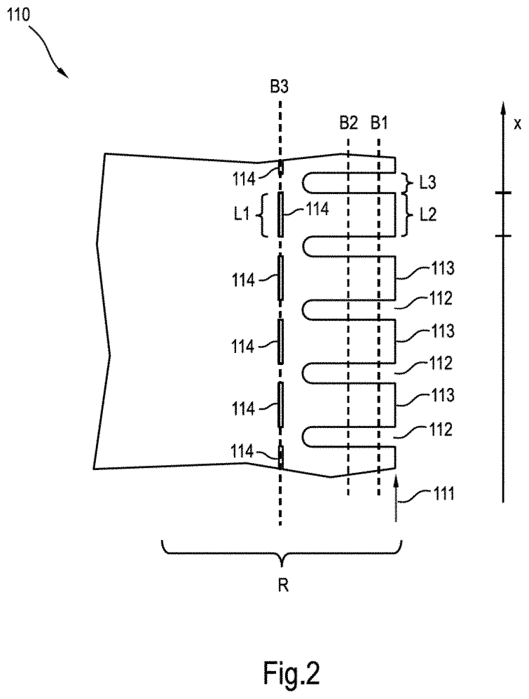

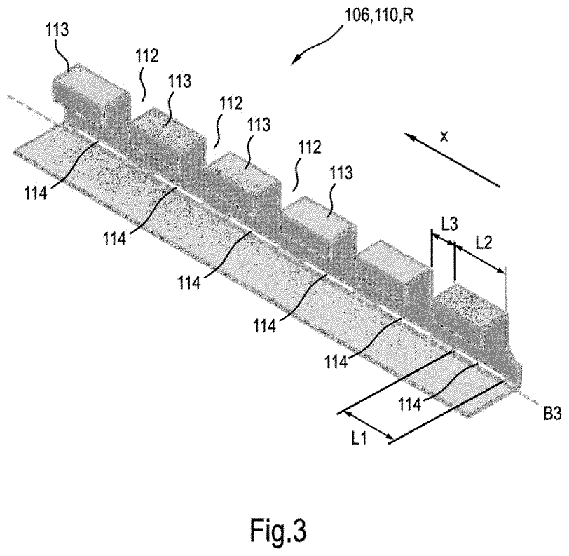

A bending process is typically used for the production of the microwave trap 106, in order to bring it into the desired shape. FIG. 2 shows a plan view of a detail of a sheet-metal component 110 with three parallel bending lines B1 to B3 drawn in, in order to create the microwave trap 106. FIG. 3 shows an oblique view of a sectional detail of the finished microwave trap 106. The sheet-metal component 110, which prior to the start of the bending process is still flat at least in one edge region R, has a free edge 111 running along a longitudinal extension x, from which project a row of equidistant recesses (“tooth recesses” or “tooth spaces”) 112, in particular perpendicularly into the sheet-metal component 110. The tooth recesses 112 of the length L3 can be created e.g. by punching, laser cutting, etc. The tooth recesses 112 create teeth 113 of the length L2 between themselves or they separate teeth 113 from one another. The length L2 can be determined at the free edge 111, at a first bending line B1 next to the free edge 111 or at a second bending line B2 next but one to the free edge 111. A length L2 of the teeth 113 typically lies in a range between 1.5 cm and 3 cm.

Whereas the first bending line B1 and the second bending line B2 run in parallel to the longitudinal extension x through the tooth recesses 112 and teeth 113, a third bending line (“main bending edge”) B3 runs from the viewpoint of the free edge 111 behind the tooth recesses 112 and teeth 113.

A row of equidistant slots (“bending slots”) 114 runs on the main bending edge B3. The bending slots 114 are aligned along the longitudinal direction x and are situated on the same longitudinal section as the teeth 113, this being indicated in FIG. 1 for a bending slot 114 by the two bars on the longitudinal direction x. This can also be expressed by saying that the bending slots 114 are arranged in parallel to the teeth 113 in respect of the longitudinal extension x. In this case L1=L2 typically applies, i.e. the bending slots 114 are as long as the teeth 113, that is 1.5 cm to 3 cm. The bending slots 114 thus interrupt the material of the sheet-metal component 110 in the region of the teeth 113. Without this slotting or these bending slots 114 a bending process could in practice be accomplished technically only with difficulty because of the continuous material at the main bending edge B3.

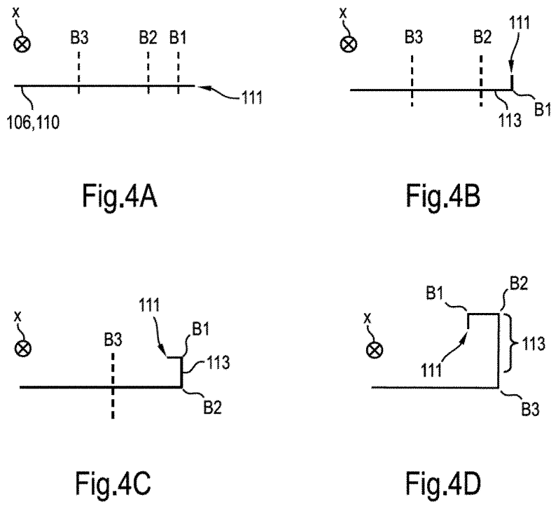

FIG. 4A shows the metal sheet 110 as a sectional view through a tooth 113 seen from the side prior to being bent at the edge to form the microwave trap 106. FIG. 4B shows the metal sheet 110 as a sectional view seen from the side after being bent by −90° along the first bending line B1 (i.e. from the direction of view perpendicularly anticlockwise). FIG. 4C shows the metal sheet 110 as a sectional view seen from the side after being subsequently bent by −90° along the second bending line B2. FIG. 4D shows the metal sheet 110 as a sectional view seen from the side after being subsequently bent by −90° along the main bending edge B3. The bent teeth 113 can also be referred to as “septal teeth” in the shape then produced.

For a microwave trap 106 produced by this bending it has disadvantageously been shown that it often cannot satisfactorily achieve its purpose, of producing impermeability to microwaves in the door gap of the door 104, but that the escaping leakage rate is considerably higher (e.g. by a factor of 10) than would be expected from simulations and experience. The reason for this has hitherto been unknown.

It is the object of the present invention to overcome at least partially the disadvantages of the prior art and in particular to provide in a constructionally simple manner a microwave trap with teeth which is produced from a sheet-metal component by bending and which exhibits an improved impermeability to microwaves.

This object is achieved in accordance with the features of the independent claims. Advantageous forms of embodiment form the subject matter of the dependent claims, the description and the drawings.

The object is achieved by a household microwave appliance, having a microwave treatment chamber, the loading opening of which can be closed by means of a door, and having at least one microwave trap for preventing microwaves escaping when the door is closed, wherein
the microwave trap is a bent sheet-metal component with a bending edge (“main bending edge”), which is adjoined by a row of teeth at a distance.
a row of bending slots is present in the main bending edge, of which at least one bending slot is interrupted by at least one web.

This household microwave appliance has the advantage that thanks to a constructionally simple modification of the bending slots which can be implemented with a virtually neutral effect on costs, the impermeability to microwaves can be markedly improved or the impermeability to microwaves achieved lies close to values calculated from conventional simulations, such that it is possible to dispense with a complex, untargeted modification of dimensions of the teeth and recesses. Thanks to the effective impermeability to microwaves more metal components can furthermore advantageously be designed in the immediate vicinity of the trap or distances from the microwave trap that were previously necessary can be reduced.

The modification of the bending slots is based on the surprising finding that the conventional bending slots firstly cause a marked shift in the effective frequency of the microwave trap and secondly case a markedly increased field deflection to adjacent metal parts:

Commercial microwave appliances have an operating frequency of 2.45 GHz±approx. 20 MHz. For a high screening effect the effective frequency of the microwave trap should be in the same frequency range as the operating frequency. If a microwave deflection of the microwave trap takes place without taking the bending slots into consideration, the actual effective frequency will deviate from the calculated/expected effective frequency. And it has indeed been shown that by using conventional bending slots a frequency deviation is produced in the effective frequency which increases the leakage radiation in the center by a factor of approximately 10. Nevertheless, in order to obtain a microwave trap in practice with low leakage radiation, the dimensioning of the teeth is changed in a complex manner by trial and error, until the effective frequency of the microwave trap lies at the desired value. The introduction of the inventive webs considerably reduces the undesired shift in the effective frequency, such that it is possible to dispense with complex trials for the dimensioning of the teeth. Specifically, the effective frequency can be predetermined precisely with simulations, taking into consideration the bending slots and webs.

A further negative effect occurs as a result of evanescent microwave fields. Since even the conventional bending slot is impermeable for microwave radiation, the electromagnetic microwave field on the outside of the door behind the bending slot decreases exponentially in strength and is no longer capable of propagation. However, if there is an electrically conductive component on the outside of the door in the immediate vicinity of a bending slot, the evanescent field can couple into this component, such that it now acts as an antenna. Microwaves can as a result once again be emitted in the form of locally greatly increased leakage radiation. Metal components such as these occur frequently in the practical implementation of doors, for example in the form of a hinge or other fastening devices of the door. The occurrence of such evanescent fields or of coupling out of evanescent fields on the outside of the bending slots cannot be influenced by varying the geometry of the teeth, since a frequency misalignment is not the cause of the occurrence of the evanescent fields. Thus hitherto the only solution has been to keep critical metal parts out of the external region of the bending slots, although this can be functionally disadvantageous and/or constructionally complex. It has now been shown that by introducing a web into the bending slot the coupling out of evanescent fields on the outside of the bending slots is largely suppressed and thus the escape of leakage radiation is prevented in practice.

The household microwave appliance can in particular be a microwave cooking appliance. The household microwave appliance can be a standalone microwave appliance or a microwave combination appliance, for example a microwave appliance with an additional IR heat source (e.g. at least one resistance heating conductor) and/or steam treatment functionality. In one development, the household microwave appliance is an oven with microwave functionality.

Microwaves can be applied to the microwave treatment chamber. In the case of a microwave cooking appliance this can also be referred to as a cooking chamber. The loading opening is in particular a front loading opening. The door is a door that is impermeable to microwaves.

The fact that the main bending edge is adjoined by a row of teeth at a distance means that the teeth or the recesses/gaps separating the teeth from one another do not extend to the main bending edge. Rather, a strip of material which in particular is continuous in the longitudinal direction or longitudinal extension is present between the main bending edge and the teeth.

A bending slot can generally be understood as a material weakening (e.g. an opening or a hole) in the sheet-metal component which at least in part lies on the main bending edge or is arranged at the main bending edge. The bending slot can for example be embodied as a hole with a straight, oval, rectangular, circular or polygonal contour. In one development, the bending slot is at least as long (along the extension of the main bending edge) as it is wide (at a right angle to the extension of the main bending edge). In one development, the bending slot is longer than it is wide, in particular at least twice as long.

In one development, all bending slots have the same shape and/or size. In one development, at least two bending slots have a shape and/or size different to one another.

The shape of the web can also be variably selected, e.g. with a shape at a right angle to the main bending edge which is rectangular, concave, convex, polygonal, etc. What is important is the function as an electrically conductive connection to bridge the bending slot.

In an advantageous configuration to implement bending along the main bending edge while ensuring high mechanical stability, the bending slot is arranged in parallel to the teeth. This means that each of the bending slots is situated completely on a longitudinal section of the main bending edge, which is also covered by the associated tooth. In other words, the bending slot is then situated inside the longitudinal section of the associated tooth. In this case the condition L1≤L2 applies if a length of the bending slot is designated by L1 and a length of the associated tooth is designated by L2.

In one development, no bending slots are arranged in a longitudinal section of a recess, thereby producing the advantage that leakage radiation as a result of evanescent fields can be reduced particularly effectively, since bending slots can be dispensed with in the region of the recesses. This can therefore be implemented noncritically in terms of material technology, because bent material can deform comparatively easily in the region of the recesses thanks to its short distance from a free edge.

However, a bending slot can generally also extend over the longitudinal section of the associated tooth, namely in one longitudinal direction or in both longitudinal directions, but in particular not as far as the adjacent tooth or as far as the longitudinal section covered by an adjacent tooth. L1=L2±10% can generally advantageously apply.

In one development, L1 and/or L2 lie in a range [1.5 cm; 3 cm].

A length L3 of a recess can advantageously lie between 0.4·L2 and 0.6·L2, in particular can be approx. 0.5·L2.

The fact that a bending slot is interrupted by a web includes or means in particular that the web traverses the bending slot.

In one configuration, multiple, in particular all, bending slots are interrupted by at least one web. Thus the leakage rate for particularly long regions of the door gap is effectively reduced, in particular in the entire circumference of the loading opening or of the door gap.

In one configuration, a length of the slot sections separated by the at least one web is less than 1 cm, in particular not greater than 0.95 cm, in particular not greater than 0.9 cm, in particular not greater than 0.85 cm, in particular not greater than 0.8 cm, in particular not greater than 0.75 cm. This is because it has surprisingly been shown that appreciable evanescent microwave fields escape to the outside from a slot or slot section which is longer than 1 cm, but when the slot section is reduced to less than 1 cm a significant reduction in the associate leakage rate occurs and at approx. 0.8 cm the evanescent microwave fields are in practice negligible. The advantage achieved by this is that by adjusting a slot length to less than 1 cm a leakage rate can be significantly reduced. In this case the bending slots can be arranged arbitrarily on the main bending edge, in other words also in parallel to tooth spaces, etc. However, it is particularly advantageous if the bending slots are arranged in parallel to the teeth.

In one possible development in which a length of the slot sections is less than 1 cm, the, in particular all, slot sections are arranged equidistantly along the main bending line, similarly to a perforation. In this case the distance between two adjacent slot sections of different bending slots corresponds to the distance between the slot sections of a common bending slot. This can be implemented particularly easily in terms of production technology. In this case it is advantageous if in parallel to a tooth at least 75% of the length of the main bending edge is recessed or is configured as slot sections, in particular at least 80%, in particular at least 85%, in particular at least 90%. It is also advantageous if in parallel to a tooth not more than 95% of the length of the main bending edge is recessed or is configured as slot sections.

In one development, it is advantageous for ease of bending and for making the bending slots for a length of the slot sections to be at least 0.5 cm.

In one configuration, at least one of the bending slots is interrupted by precisely one web. This configuration can be implemented particularly easily. In one development, the precisely one web traverses the bending slot centrally and the resultant slot sections separated by the web are equal in length. In one development, all bending slots provided with the at least one web are in each case interrupted by precisely one web.

In one configuration, at least one of the bending slots is interrupted by multiple webs. This configuration has the advantage that the effective frequency of the microwave trap can be brought particularly close to the effective frequency of a main bending edge that is not interrupted or provided with bending slots. In one development, the multiple webs are arranged equidistantly in the bending slot and the resultant slot sections separated by the web are hence of equal length. In one development, all bending slots provided with the at least one web are in each case interrupted by multiple webs.

In one development, the web or webs of a bending slot are not arranged centrally or all equidistant to one another. As a result, there are at least two slot sections of different lengths. This may be advantageous for yet another increase in the effectiveness of a microwave shielding. It is therefore generally possible for the slot sections of a bending slot created by the at least one web to be of equal length or of different lengths.

In one configuration, the at least one web has a length of in each case at least approximately 2 mm. This has proved to be a particularly good compromise between an increase in effectiveness of a microwave shielding and a mechanically robust design that can be implemented inexpensively.

In one configuration, the webs and slots are arranged cyclically along the entire bending edge, including in the region of the recesses 112, as a result of which a continuous perforation is created.

In one development, the tooth is what is known as a “septal tooth”. In this way a particularly effective microwave trap can be provided. A septal tooth is in particular to be understood as a tooth which starting from the main bending edge to the free edge is bent twice in the same direction, specifically by in each case at least approximately 90° or −90°. The septal tooth is, starting from the main bending edge, in particular U-shaped in cross-section, wherein the section between the free edge and the closest first bending edge thereto is shorter than the parallel section between the main bending edge and the second bending edge closest thereto.

In one configuration, the microwave trap is a part or region of a door of the household microwave appliance. Alternatively or additionally, the microwave trap can be a part or region of a flange covering the loading opening and thus the door in the closed state. In one configuration, the microwave trap is produced by bending an edge region of a door panel or housing panel.

The object is also achieved by a microwave trap as described above. In this, bending slots provided with webs are made in the sheet-metal component in particular along an intended main bending edge in parallel at a distance from a row of teeth arranged on the remote edge.

The object is additionally achieved by a door of a household microwave appliance and/or a flange surrounding a loading opening of a household microwave appliance which is fitted with such a microwave trap.

The object is also achieved by a method for the production of a microwave trap of a household microwave appliance made of a sheet-metal component, in which
bending slots provided with webs are made in the sheet-metal component along an intended main bending edge in parallel at a distance from a row of teeth arranged on the remote edge and
the sheet-metal component is bent at the main bending edge.

The method can be configured analogously to the household microwave appliance, and vice versa, and has the same advantages.

The webs are in particular created by making the slot sections spaced apart in the sheet-metal component, and not by making the bending slots in one piece in the sheet-metal component and then adding the webs again subsequently.

In one configuration, a sheet-metal component used to produce the microwave trap is additionally reshaped by deep drawing, e.g.—advantageously—prior to the bending operation for the production of the microwave trap and/or thereafter. The advantage of this is that the sheet-metal component can be shaped in a particularly complex manner.

The properties, features and advantages described above of this invention and the way in which these are achieved will become clearer and more comprehensible in connection with the following schematic description of an exemplary embodiment, which is explained in greater detail in connection with the drawings.

FIG. 1 shows as a sectional view seen from the side a sketch of a basic structure of a household microwave appliance in the form of a microwave cooking appliance with a microwave trap;

FIG. 2 shows in a plan view a detail from a sheet-metal component, from which a conventional microwave trap can be created by bending;

FIG. 3 shows in an oblique view a sectional detail from the finished conventional microwave trap;

FIG. 4A to 4D show as sectional views seen from the side in sketch form the sheet-metal component from FIG. 3 in different sections of a bending process for the production of the microwave trap from FIG. 3;

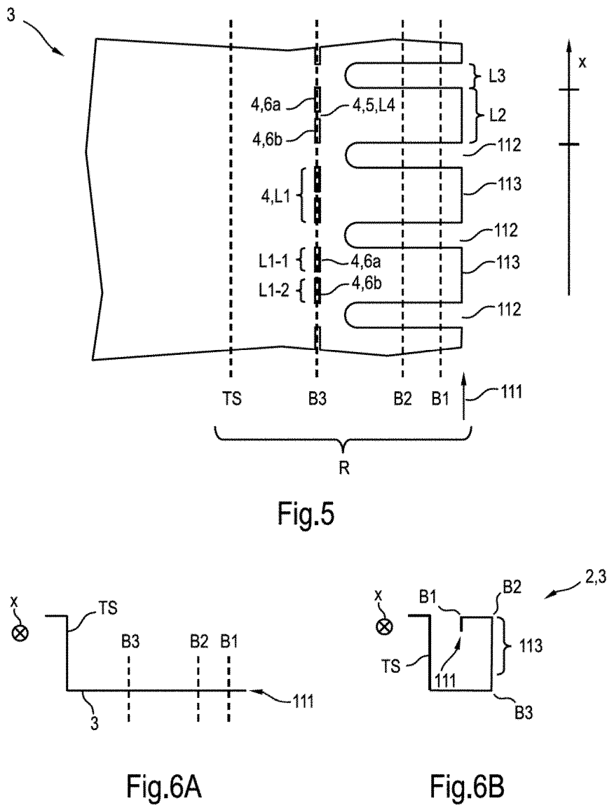

FIG. 5 shows in a plan view a detail from a sheet-metal component, from which an inventive microwave trap in accordance with a first exemplary embodiment can be created by bending;

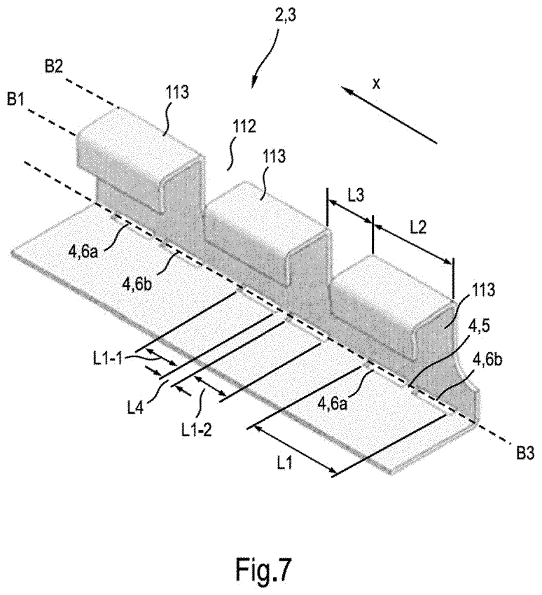

FIGS. 6A and 6B show as sectional views seen from the side in sketch form the sheet-metal component from FIG. 5 in different sections of a bending process for the production of the microwave trap in accordance with the first exemplary embodiment from FIG. 7;

FIG. 7 shows in an oblique view a sectional detail from the finished microwave trap in accordance with the first exemplary embodiment;

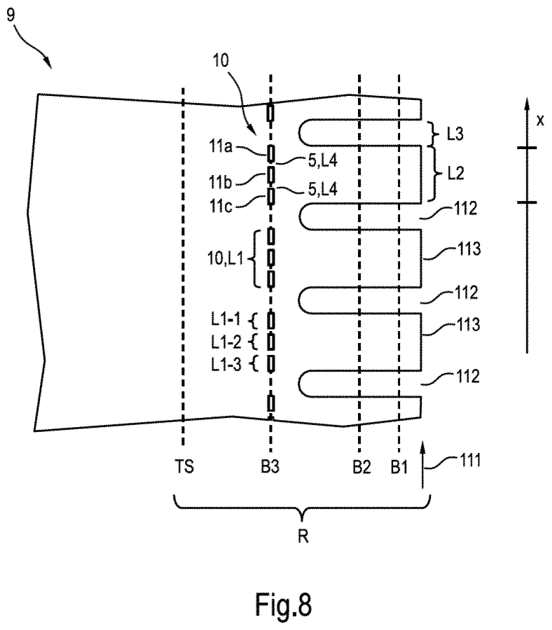

FIG. 8 shows in a plan view a detail from a sheet-metal component, from which an inventive microwave trap in accordance with a second exemplary embodiment can be created by bending;

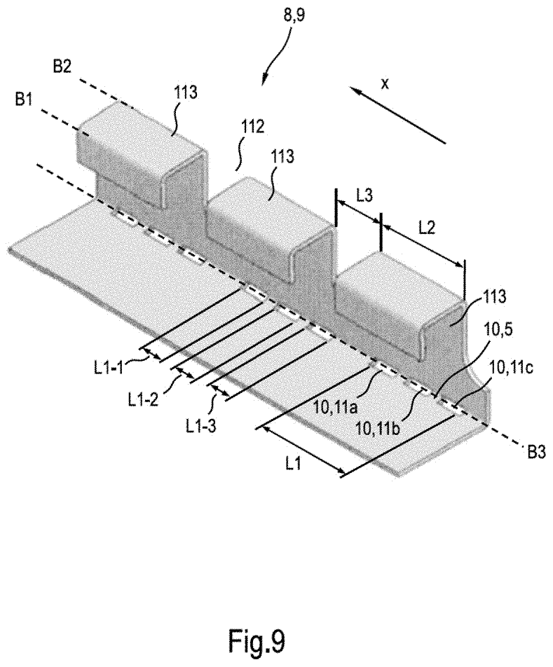

FIG. 9 shows in an oblique view a sectional detail from the finished bent microwave trap in accordance with the second exemplary embodiment; and

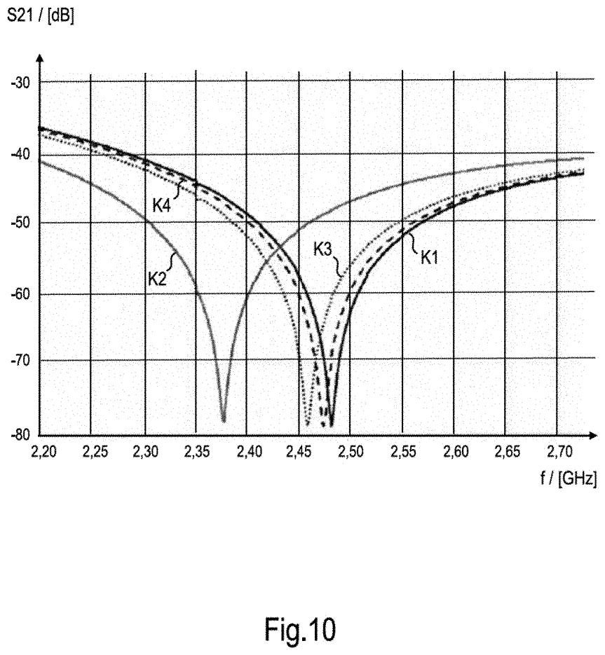

FIG. 10 shows a plot of microwave attenuation S21 in dB against a microwave frequency in GHz, plotted for microwave traps with septal teeth without bending slots, with a conventional bending slot and the bending slots in accordance with the first and second forms of embodiment.

FIG. 5 shows in a plan view in a representation analogous to FIG. 2 a detail from a sheet-metal component 3, which can be bent to form a microwave trap 2. This microwave trap 2 can be installed in a microwave cooking appliance 1 instead of the conventional microwave trap 106. The microwave cooking appliance 1 can in other respects be structured analogously to the conventional microwave cooking appliance 101.

The sheet-metal component 3 differs from the sheet-metal component 110 in that the bending slots 4 are interrupted by a web 5 (which can also be referred to as a “connection web”) or a web 5 traverses the respective bending slot 4. As a result, two slot sections 6a and 6b are created at the respective bending slot 4. The bending slot 4 can advantageously have one or more of the following properties:
the bending slot 4 is situated at the height of or in the longitudinal section of the tooth 113;
the length L1 of the bending slot 4 lies in a range L2±10%, in particular between [0.9·L2; L2];
the bending slot 4 is arranged symmetrically (i.e. not offset in respect of the longitudinal extension x) to the tooth 113;
the length of the bending slot 4 lies in a range [1.5 cm; 3 cm];
   a length L4 of the web 5 lies in a range [1 mm; 3 mm], in particular is 2 mm;
   the web 5 traverses the bending slots 4 centrally, as a result of which equal lengths L1-1 and L1-2 of the two slot sections 6a or 6b are produced;
   the lengths L1-1 and L1-2 of the two slot sections 6a or 6b are in each case not more than 0.9 cm, in particular not more than approx. 0.8 cm.

In particular, all bending slots 4 can have the same properties. Alternatively, one, more or all bending slots 4 can have at least one property differing from these properties. For example, the web 5 can eccentrically traverse one, more or all bending slots 4, in which case the two slot sections 6a and 6b have different lengths L1-1 or L1-2.

The length L3 of the recess 112 can advantageously lie between 0.4·L2 and 0.6·L2, in particular can be approx. 0.5·L2.

FIG. 6A shows in a representation analogous to FIG. 4A the metal sheet 3 as a sectional view through a tooth 113 prior to the remote-side bending to form the microwave trap 2. Here the sheet-metal component 3 is deep-drawn prior to the start of the bending process, as a result of which a deep-drawn step TS running in the longitudinal direction x is created at the edge region R. The deep drawing does not require any bending slots.

Starting from the state shown in FIG. 6A the sheet-metal component 3 can be bent analogously to FIG. 4A to FIG. 4D, as a result of which the microwave trap 2 shown in FIG. 6B is produced. The section between the two bending lines B1 and B2 is in particular transient to the plane of the sheet-metal component 3 behind the step TS. In other words, the section extends between the second bending line B2 and the main bending edge B3 over the same height as the step TS.

FIG. 7 shows, in a representation analogous to FIG. 5, a detail from the microwave trap 2.

FIG. 8 shows, in a representation analogous to FIG. 5, a detail from a sheet-metal component 9, which can be bent to form a microwave trap 8. This microwave trap 8 can likewise be installed in a microwave cooking appliance 7 instead of the conventional microwave trap 106. The microwave cooking appliance 7 can in other respects be structured analogously to the conventional microwave cooking appliance 101 or the microwave cooking appliance 1.

The sheet-metal component 9 differs from the sheet-metal component 110 in that the bending slots 10 are interrupted by two webs 5 or two webs 5 traverse the bending slot 4 at a distance from one another. As a result, three slot sections 11a, 11b and 11c are created. The bending slot 10 can advantageously have one or more of the following properties:
the bending slot 10 is situated at the height of or in the longitudinal section of the tooth 113;
the length L1 of the bending slot 10 lies in a range L2±10%, in particular between [0.9·L2; L2];
the bending slot 10 is arranged symmetrically (i.e. not offset in respect of the longitudinal extension x) to the tooth 113;
the length of the bending slot 10 lies in a range [1.5 cm; 3 cm];
a length L4 of the respective webs 5 lies in a range [1 mm; 3 mm], in particular is 2 mm;
the webs 5 traverse the respective bending slot 10 equidistantly;
the lengths L1-1 and L1-2 of the two slot sections 6a or 6b are in each case not more than 0.9 cm, in particular not more than approx. 0.8 cm.

In particular, all bending slots 10 can have the same properties. Alternatively, one, more or all bending slots 10 can have at least one property differing from these properties. For example, the webs 5 can eccentrically traverse one, more or all bending slots 10 non-equidistantly, in which case at least two of the three slot sections 11a, 11b and 11c have different lengths L1-1, L1-2 or L1-3.

The length L3 of the recess 112 can advantageously lie between 0.4·L2 and 0.6·L2, in particular can be approx. 0.5·L2.

FIG. 9 shows a detail from the microwave trap 8 in a representation analogous to FIG. 7.

FIG. 10 shows a plot of a microwave attenuation S21, which sets out the ratio of the field strengths of the microwave field in and outside the cooking chamber 102, in dB against a microwave frequency in GHz, plotted for microwave traps 106, 4 and 8 with septal teeth 113 without bending slots (continuously drawn curve K1), with a conventional bending slot 114 (continuously drawn curve K2) and the bending slots 4 (dotted curve K3) and 10 (dashed curve K4) in accordance with the first or second inventive form of embodiment.

In simulations of the microwave trap hitherto, the bending slots are not simulated at the same time, but are left out of consideration. In the associated attenuation curve K1 the attenuation minimum lies at approx. 2.48 GHz.

If conventional bending slots 114 are now taken into consideration in the simulation, the attenuation minimum shifts by more than 100 MHz, as shown in the attenuation curve K2.

A deviation such as this produces a markedly increased leakage rate, if a microwave frequency in the microwave treatment chamber of approx. 2.48 GHz is assumed. The leakage rate is then typically increased by approximately a factor of 10.

By introducing just one web 5 into the bending slots 4 the attenuation minimum is closely approximated to the situation without bending slots, in attenuation curve K3 for example it is approx. 2.46 GHz. For the example shown, this frequency corresponds to a desired target operating frequency. As a result, the leakage rate can be effectively reduced.

By introducing two webs 5 into the bending slots 10 the attenuation minimum is approximated even further to the situation without bending slots (see attenuation curve K4).

The above simulations are performed for an operating range of the microwave frequency by way of example in a frequency range typical thereof of approx. 2.46 GHz±20 MHz. The specifically desired frequency range is a function of specific properties of the cooking appliance and of the microwave generator. Analogous results have also been obtained for an operating range between 902 MHz and 928 MHz.

The present invention is not of course restricted to the exemplary embodiment shown.

Thus the teeth can also be shaped differently, for example L-shaped or straight in cross-section. Furthermore, when at a right angle to the bending lines they can have a non-rectangular shape. e.g. wave-like or conical, etc.

In general “a”. “an”, etc. can be understood as a singular or a plural, in particular in the sense of “at least one” or “one or more”, etc., so long as this is not explicitly excluded, e.g. by the expression “precisely one”, etc.

A figure quoted can also include precisely the number stated as well as a customary tolerance range, so long as this is not explicitly excluded.

### LIST OF REFERENCE CHARACTERS

1 Microwave cooking appliance
2 Microwave trap
3 Sheet-metal component
4 Bending slot/microwave trap
5 Web
6a First slot section
6b Second slot section
7 Microwave cooking appliance
8 Microwave trap
9 Sheet-metal component
10 Bending slot
11a First slot section
11b Second slot section
11c Third slot section
101 Microwave cooking appliance
102 Cooking chamber
103 Loading opening
104 Door
105 Flange
106 Microwave trap
107 Cover
108 Microwave generator
109 Rotary antenna
110 Sheet-metal component
111 Free edge
112 Recess
113 Tooth
114 Bending slot
f Microwave frequency
B1-B3 Bending lines
K1-K4 Attenuation curves
L1 Length of the bending slot 4
L1-1 Length of the first slot section
L1-2 Length of the second slot section
L1-3 Length of the third slot section
L2 Length of the tooth
L3 Length of the recess
L4 Length of the web
R Edge region
S21 Microwave transmission
TS Deep-drawn step
x Longitudinal extension

1-15. (canceled)

16. A household microwave appliance, comprising:
a microwave treatment chamber having a loading opening;
a door for closing the loading opening of the microwave treatment chamber; and
a microwave trap configured to prevent microwaves escaping when the door is closed, said microwave trap being a bent sheet-metal component with a main bending edge, which is adjoined by a row of teeth at a distance, said microwave trap including a row of bending slots in the main bending edge, with at least one of the bending slot being interrupted by at least one web to define slot sections.

17. The household microwave appliance of claim 16, wherein the bending slots are arranged in parallel to the teeth.

18. The household microwave appliance of claim 16, wherein the slot sections have a length which is not greater than 1 cm.

19. The household microwave appliance of claim 16, wherein the slot sections have a length which is not greater than 0.9 cm.

20. The household microwave appliance of claim 16, wherein the slot sections have a length which is not greater than 0.8 cm.

21. The household microwave appliance of claim 16, wherein the at least one of the bending slots is interrupted by precisely one said web.

22. The household microwave appliance of claim 16, wherein the at least one web traverses the at least one of the bending slots centrally.

23. The household microwave appliance of claim 16, wherein the at least one web traverses the at least one of the bending slots eccentrically.

24. The household microwave appliance of claim 16, wherein the at least one of the bending slots is interrupted by multiple of said web.

25. The household microwave appliance of claim 24, wherein the multiple webs traverse the at least one of the bending slots equidistantly.

26. The household microwave appliance of claim 24, wherein the multiple webs traverse the at least one of the bending slots non-equidistantly.

27. The household microwave appliance of claim 16, wherein the at least one web has a length of at least approximately 2 mm.

28. The household microwave appliance of claim 16, wherein one of the bending slots is arranged completely inside a longitudinal section of a corresponding one of the teeth which is arranged in parallel to the one of the bending slots.

29. A method for producing a microwave trap of a household microwave appliance from a sheet-metal component, said method comprising:
forming bending slots in the sheet-metal component along an intended main bending edge at a distance from a row of teeth arranged on a remote edge, with each of the bending slots being interrupted by a web to define slot sections; and
bending the sheet-metal component at the intended main bending edge.

30. The method of claim 29, further comprising reshaping the sheet-metal component by deep drawing.

31. The method of claim 29, wherein the slot sections have a length along the main bending edge of not more than 0.9 cm.

32. The method of claim 29, wherein the slot sections have a length along the main bending edge of not more than 0.8 cm.

33. The method of claim 29, wherein the bending slots are formed in the sheet-metal component in parallel to the teeth.
